(19) United States
(12) Patent Application Publication
(10) Pub. No.: US 2009/0114368 A1
(43) Pub. Date: May 7, 2009

(54) HEATED OR COOLED STEERING WHEEL

(76) Inventors: Minoru Niwa, Ichinomiya city (JP); Danielle L. White, Macomb, MI (US); Stephanie A. Schneider, Ferndale, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/262,246

(22) Filed: Oct. 31, 2008

Related U.S. Application Data
(60) Provisional application No. 60/984,844, filed on Nov. 2, 2007.

(51) Int. Cl. B60H 1/00

(52) U.S. Cl. 165/42; 74/552

(57) ABSTRACT

An example steering wheel assembly includes an upper rim and a lower rim secured to the upper rim to establish a flow path. Flow within the flow path heats or cools the steering wheel.

### CROSS-REFERENCE TO RELATED APPLICATIONS

This application claims priority to U.S. Provisional Application No. 60/984,844, which was filed on Nov. 2, 2007 and is incorporated herein by reference.

### BACKGROUND

Many automotive customers desire heated or cooled steering wheels. Space and packaging restrictions prevent steering wheel manufacturers from incorporating large heating and cooling systems within steering wheel designs, such as the heating and cooling systems used in other areas of the vehicle. Many existing steering wheels utilize ducting and other components for routing airflow through the steering wheel. Adding additional components to the steering wheel for heating and cooling purposes increases costs and complicates the steering wheel designs. For at least these reasons, many steering wheels are not heated or cooled, which is undesirable for many customers.

Some steering wheels include partially hollow portions capable of directing a heating or cooling airflow, but also include rim supporting structures that block airflow. Blocking airflow limits areas of the steering wheel capable of providing a heating and cooling airflow. It would be desirable to route heating or cooling flow within a steering wheel structure without overly complicating the steering wheel design or requiring several additional components.

### SUMMARY

An example steering wheel assembly includes an upper rim and a lower rim secured to the upper rim to establish a flow path. Flow within the flow path heats or cools the steering wheel.

The example steering wheel assembly may include an upper rim portion and an lower rim portion. An upper rib is integrally molded with the upper rim portion and a lower rib is integrally molded with the lower rim portion, The upper rib is secured to the lower rib to establish a flow path and at least one of the upper rim portion and the lower rim portion include a plurality of holes for communicating flow from the flow path.

An example method of heating or cooling a steering wheel includes securing a first steering wheel portion to a second steering wheel portion to establish a flow path and moving flow through the flow path to heat or cool the steering wheel.

These and other features of the example disclosure can be best understood from the following specification and drawings, the following of which is a brief description:

### BRIEF DESCRIPTION OF THE DRAWINGS

FIG. 1 shows a partial view of an example steering wheel.

FIG. 2A shows a section view through line 2-2 of FIG. 1 in an uninstalled position.

FIG. 2B shows a section view through line 2-2 of FIG. 1 in an installed position.

FIG. 3 shows a partial view through another example steering wheel.

FIG. 4 shows a section view through line 4-4 of FIG. 3.

FIG. 5 shows a section view through line 5-5 of FIG. 3.

### DETAILED DESCRIPTION

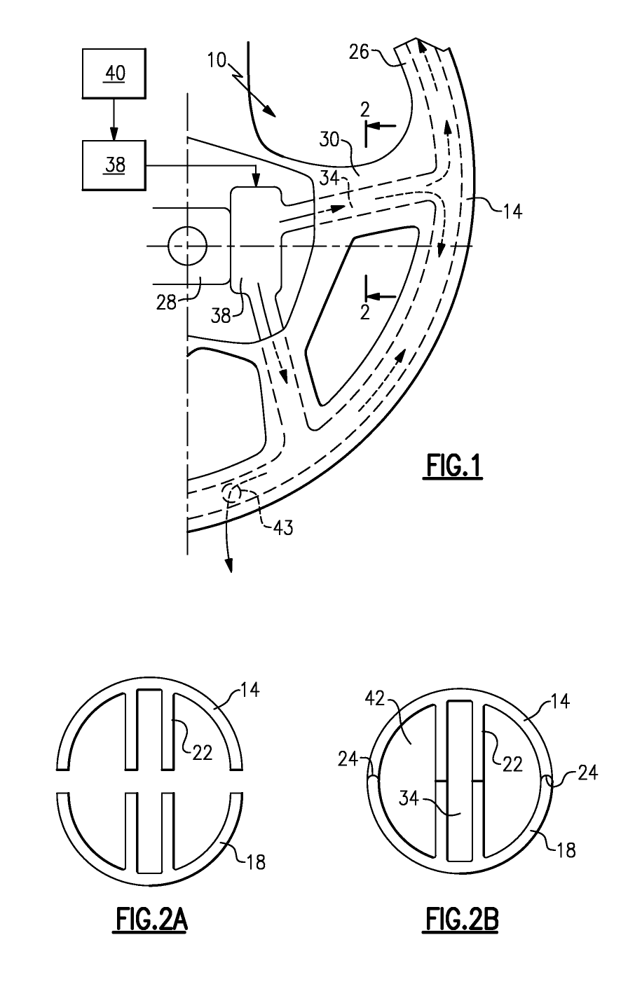

Referring to FIGS. 1 and 2, an example steering wheel 10 includes an upper half 14 attached to a lower half 18. Ribs 22 extending from one or more interior surfaces of the steering wheel 10 contact each other when the upper half 14 is attached to the lower half 18. Vibration welding at locations 24 attaches the upper half 14 to the lower half 18. In another example, the ribs 22 on the upper half 14 are also vibration welded to the ribs 22 on the lower half 18.

Another example attachment strategy comprises press-fitting the upper half 14 to the lower half 18. In such an example, the ribs 22 includes features facilitating snapping the ribs 22 together. Still other example attachment strategies include using adhesives, heat stakes, laser welds, etc. to attach the upper half 14 to the lower half 18.

When in contact, the example ribs 22 provide a flow path 34, which extends through the steering wheel 10 from a hub 28, through spokes 30, and to a rim 26. The ribs 22 also support the rim 26 and spokes 30 in this example.

Forming the upper half 14 and the lower half 18 of the steering wheel 10 from a polymer material facilitates molding the ribs 22 with the upper half 14 and the lower half 18.

A steering wheel source 38 moves a fluid, such as air, through the flow path 34. Example sources include a pump or fan. Other example fluids include refrigerants such as Freon. The fluid moves from a supply 40 through the source 38 to the flow path 34. In some examples, air within the vehicle directly provides the supply 40 of fluid. In other examples, an existing heating or cooling system within the vehicle provides the supply 40 of fluid.

In this example, fluid moving from the source 38 to the flow path 34 is already heated or cooled to a desired temperature. In other examples, Freon or other fluids held within a chamber 42 adjacent the flow path 34 further heat or cool the fluid after the fluid moves through the source 38.

The fluid within the flow path 34 heat or cools the upper half 14 and the lower half 18 of the steering wheel 10. In this example, an outlet 43 in the lower half 18 of the steering wheel 10 allows fluid to move from the flow path 34 to the interior of the vehicle after heating or cooling the steering wheel 10.

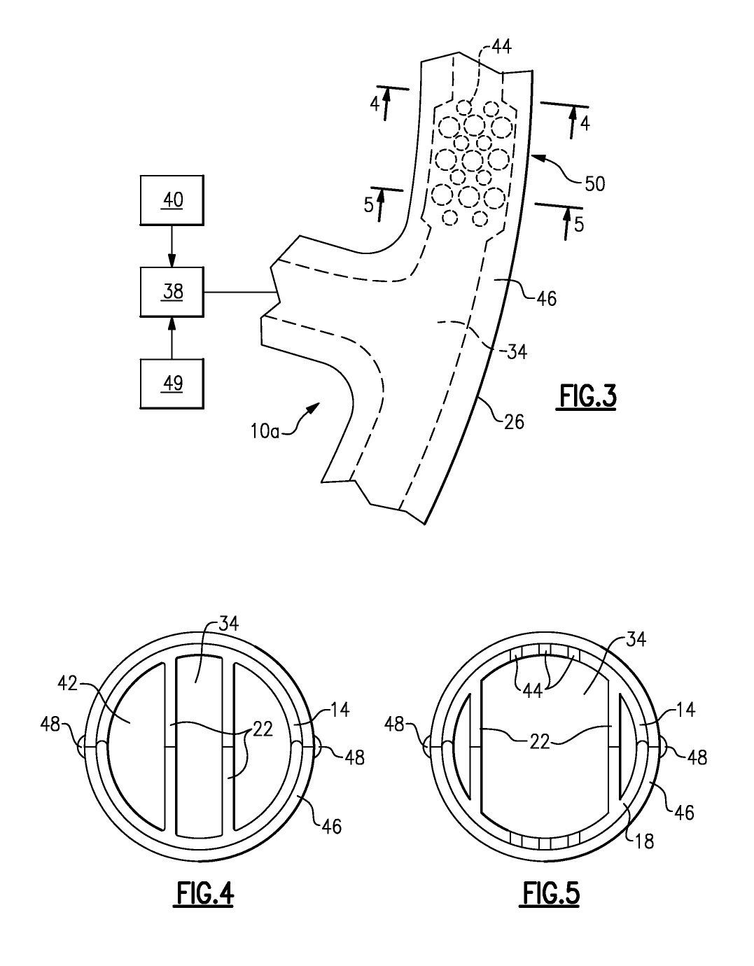

Referring now to the example of FIGS. 3-5, fluid directed through the flow path 34 exits the rim 26 through holes 44. In this example, fluid from the holes 44 moves through a wrap 46 secured around the rim 26 with stitches 48. The example wrap 46 covers the holes 44 so that the driver's hands do not contact or otherwise perceive the holes 44. In this example, the wrap 46 is leather and enhances the aesthetic appeal of the steering wheel 10a. The wrap 46 is vinyl in another example.

In this example, fluid moving through the flow path 34 and exiting the holes 44 cools or heats the steering wheel 10a. Flow from the holes 44 concentrates the perceived heating or cooling effect to the areas of the steering wheel 10a having the holes 44. Changing the temperature and speed of the fluid flow from the holes 44 can adjust the heating or cooling to a level desired by the driver, for example. In this example, the driver adjusts a switch 49 to control the heating or cooling affect by controlling the flow and temperature of fluid moving through the flow path 34. As known, a driver's hand grasps the steering wheel 10a to manipulate the position of the vehicle.

Adjusting the location and arrangement of holes 44 changes the cooling or heating pattern on the driver's hand. The driver typically desires to grasp areas of the steering wheel 10a that provide the greatest heating or the greatest cooling effect on the driver's hand.

In this example, an area 50 of the rim 26 corresponding to the two o'clock position includes groups of the holes 44. The area 50 is thus a primary area of the rim 26 having a heating or cooling effect on the driver's hand, which encourages the driver to contact the rim 26 at the area 50. As known, contacting the steering wheel 10a at the ten o'clock and two o'clock positions is desirable as the driver tends to better control the steering wheel 10a when grasping those areas of the steering wheel 10a. Concentrating flow in those areas encourages such behavior.

This flow path 34 also is wider in the area 50 to facilitate including more holes 44 that communicate fluid from the flow path 34 and concentrate the heat or cold fluid in the area 50. In another example, the ten o'clock and two o'clock positions include a greater density of similarly sized holes 44 than other areas of the rim 26. Increasing the density of similarly sized holes 44 in a particular area of the rim 26 increases the flow of the fluid through that area of the rim 26. The ribs 22 establish the flow path 34 in this example, but other examples may include establishing the flow path 34 without using ribs 22.

In some examples, the configurations, such the size and the position, of the holes 44 is adjusted to obtain a desired performance of the steering wheel 10 when loaded. One example of a desired performance is fracturing or bending at a particular rim 26 location. Areas having a greater density of the holes 44 tend to yield under less load than areas having fewer of the holes 44. Thus, some examples of the steering wheel 10a increase the density of the holes 44 in an area where yield under load is desired.

Forming the upper half 14 and the lower half 18 of the steering wheel 10 from a polymer material facilitates molding the ribs 22 and the holes 44 with the upper half 14 and the lower half 18.

Although a preferred embodiment has been disclosed, a worker of ordinary skill in this art would recognize that certain modifications would come within the scope of this invention. For that reason, the following claims should be studied to determine the true scope and content of this invention.

We claim:

1. A steering wheel assembly, comprising
an upper rim; and
a lower rim secured to the upper rim to establish a flow path, wherein flow within the flow path heats or cools the steering wheel.

2. The steering wheel assembly of claim 1, wherein at least one of the upper rim and the lower rim comprise ribs that contact the other of the upper rim and the lower rim to establish the flow path.

3. The steering wheel assembly of claim 2, wherein the ribs are molded with the at least one of the upper rim and the lower rim.

4. The steering wheel assembly of claim 1, wherein the flow path extends from a hub portion of the steering wheel to a rim portion of the steering wheel.

5. The steering wheel assembly of claim 1, wherein the flow provides a driver with a perceived heating effect, a perceived cooling effect, or both.

6. The steering wheel assembly of claim 1, wherein the upper rim and the lower rim comprise a polymer material.

7. The steering wheel assembly of claim 1, wherein flow communicates from the flow path through holes in at least one of the upper rim and the lower rim.

8. The steering wheel assembly of claim 7, wherein at least one area of the upper rim and the lower rim includes a greater density of holes than another areas of the upper rim and the lower rim to facilitate grasping the at least one area.

9. The steering wheel assembly of claim 7, including a wrapped layer adjacent a portion of at least one of the upper rim and the lower rim, the flow operative to communicate through the holes and through the wrapped layer.

10. The steering wheel assembly of claim 9, wherein the wrapped layer covers at least some of the holes.

11. The steering wheel assembly of claim 9, wherein the wrapped layer comprises leather.

12. A steering wheel assembly, comprising
an upper rim portion;
a lower rim portion;
an upper rib integrally molded with the upper rim portion; and
a lower rib integrally molded with the lower rim portion, wherein the upper rib is secured to the lower rib to establish at least a portion of a flow path and at least one of the upper rim portion and the lower rim portion include a plurality of holes for communicating flow from the flow path.

13. The steering wheel assembly of claim 12, wherein the flow is air flow.

14. The steering wheel assembly of claim 12, wherein the flow is a heated or a cooled flow.

15. The steering wheel assembly of claim 12, wherein at least one of the upper rim portion and the lower rib portion establishes a chamber that holds a second fluid, the second fluid operative to heat or cool the flow communicating though the flow path.

16. A method of heating or cooling a steering wheel, comprising:
securing a first steering wheel portion to a second steering wheel portion to establish a flow path; and
moving flow through the flow path to heat or cool the steering wheel.

17. The method of claim 16, including moving flow through holes in at least one of the first steering wheel portion and the second steering wheel portion.

18. The method of claim 17, including configuring the holes to move more flow through at first area of the steering wheel than a second area of the steering wheel.

19. The method of claim 17, including configuring the holes to facilitate steering wheel yield under load at a desired areas of the steering wheel.

20. The method of claim 17, including molding ribs in at least one of the first steering wheel portion and the second steering wheel portion to establish the flow path.
